(19) United States
(12) Patent Application Publication
(10) Pub. No.: US 2020/0073607 A1
(43) Pub. Date: Mar. 5, 2020

(54) IMAGE FORMING APPARATUS AND IMAGE FORMING METHOD

(71) Applicant: KONICA MINOLTA, INC., Tokyo (JP)

(72) Inventor: Yuji UCHIDA, Tokyo (JP)

(21) Appl. No.: 16/556,414

(22) Filed: Aug. 30, 2019

(30) Foreign Application Priority Data
Sep. 4, 2018 (JP) 2018-165011

(51) Int. Cl. G06F 3/12

(52) U.S. Cl. CPC G06F 3/1239; G06F 3/1219; G06F 3/1208

(57) ABSTRACT

Provided is an image forming apparatus for forming images of a plurality of pages on continuous paper according to image data of the images. The image forming apparatus includes: a coverage calculating section that calculates a moving average coverage over a predetermined print length using the image data before starting a print job; and an operation control section that controls an image forming operation related to toner usage according to a result of comparison between the moving average coverage and one or both of a predetermined maximum threshold and a predetermined minimum threshold.

### CROSS-REFERENCE TO RELATED APPLICATIONS

The present application claims priority under 35 U.S.C. § 119 to Japanese Patent Application No. 2018-165011, filed Sep. 4, 2018, the contents of which are incorporated herein by reference in their entirety.

### BACKGROUND

### Technological Field

The present invention relates to an image forming apparatus and an image forming method.

### Description of the Related Art

An image forming apparatus such as a printer forms an image on a sheet called a cut sheet cut to a predetermined size such as A4 or B4, according to image data of the image to be printed. This type of the image forming apparatus can also form an image on a rolled continuous sheet (continuous paper), which is called roll paper, by combining a paper feeding device and a paper discharge device. In this case, the image forming apparatus forms images of a plurality of pages according to the image data thereof on continuous paper. Hereinafter, the operation of forming images of a plurality of pages on continuous paper is referred to as “continuous printing”.

The image forming apparatus may damage the machine (components) when continuously forming images each consuming a small amount of toner (developer), i.e. images with low density, in continuous printing.

Therefore, the conventional image forming apparatus manages the amount of toner usage by calculating a coverage after forming an image, on a per-page basis. The coverage is information related to the amount of toner used per unit area. The coverage is calculated by the following formula: coverage=(sum of density values of pixels)±(sum of density values in the case of 100%-density pixels printed on the entire surface). The coverage is 0% in a blank state (non-printing state) and 100% in a solid printing (entire printing) state.

The conventional image forming apparatus prevents machine damages, for example, by either of the following operation controls 1 and 2 in consideration of continuous printing with low coverage (for example, a coverage value of 3% or less), which is a severe condition for the machine.

Operation control 1: Continuous printing is limited to a predetermined length (hereinafter, referred to as “limited length” for convenience).

Operation control 2: Continuous printing is allowed up to a certain length longer than the limited length (hereinafter referred to as “allowable length” for convenience) by inserting a toner consumption band at an end of each sheet to increase the amount of consumption of the toner to a certain level or more (see, for example, Japanese Patent Application Publication No. 2006-91538).

The “limited length” described above is a print length that the machine (component) can withstand continuous printing under the most severe condition for the machine (for example, a condition where the coverage is 0%). Hereinafter, descriptions are given assuming that the “limited length” is 300 meters by way of example. In addition, descriptions are given also assuming that the “allowable length” is 1000 meters.

### SUMMARY

As described below, there has been a demand for improving the process performance of printing images of a plurality of pages on continuous paper by conventional image forming apparatuses.

The conventional image forming apparatus has been configured to ask a user whether to continue printing each time when the length of the continuous printing exceeds the limited length even when the printing can be continuously performed without problems. Thus, it is often that the printing process is interrupted when using conventional image forming apparatuses. When the printing process is interrupted, a gap area is formed on the continuous paper. Some users dislike the formation of the gap area. Thus, interruption of the printing process is not preferable. In addition, when the printing process is interrupted, the print performance is slowed accordingly. Thus, there has been a demand for reducing the interruption of the printing process to improve the capability of the conventional image forming apparatuses.

In addition, the conventional image forming apparatuses calculate coverage after forming an image per page, to manage the amount of the toner usage. Such a conventional image forming apparatus takes a certain time to calculate the coverage.

In addition, the conventional image forming apparatus is not able to inform the user how the next print job will be performed during continuous printing. Specifically, the conventional image forming apparatus is configured to interrupt the current printing process unconditionally when the length of the continuous printing exceeds the limited length and to ask the user what processing should be performed. Therefore, there has been a demand for reducing the interruption of the printing process to improve the performance of the conventional image forming apparatuses and for configuring image forming apparatuses to provide good usability (i.e., to inform, during the printing process, the user how the next print job will be performed).

General image forming apparatuses each have a hopper for storing toner used for image formation, and a toner supply part for supplying the toner to the hopper. The toner in the hopper becomes damp when left for a long time (for example, about 6 hours). In such a case, a toner concentration sensor provided in the hopper may not be able to correctly measure the toner concentration (density) in the hopper. The conventional image forming apparatus supplies the toner at a predetermined constant supply rate until the toner in the hopper is replaced while printing at a constant printing speed without changing the printing speed. In such a conventional image forming apparatus, the toner in the hopper may be exhausted and the printing process may be interrupted. Therefore, also from this point of view, there has been a demand for reducing the interruption of the printing process to improve the performance of the conventional image forming apparatuses.

An object of the present invention is to improve the process performance of printing images of a plurality of pages on continuous paper.

To solve at least one of the above-mentioned problems, an image forming apparatus reflecting one aspect of the present invention includes: a coverage calculating section that calculates a moving average coverage over a predetermined print length using image data of images of a plurality of pages before starting a print job; and an operation control section that controls an image forming operation related to toner usage according to a result of comparison between the moving average coverage and one or both of a predetermined maximum threshold and a predetermined minimum threshold.

Moreover, to solve at least one of the above-mentioned problems, an image forming method reflecting one aspect of the present invention includes: calculating a moving average coverage over a predetermined print length using image data of images of the plurality of pages prior to starting a print job; comparing the moving average coverage with one or both of a predetermined maximum threshold and a predetermined minimum threshold; and controlling an image forming operation related to toner usage in such a way that a result of the comparison is reflected in the image forming operation.

### BRIEF DESCRIPTION OF THE DRAWINGS

The advantages and features provided by one or more embodiments of the invention will become more fully understood from the detailed description given hereinbelow and the appended drawings which are given by way of illustration only, and thus are not intended as a definition of the limits of the present invention:

FIG. 1 is a configuration diagram of an entire image forming system including an image forming apparatus according to an embodiment;

FIG. 2 is an internal block diagram of the image forming apparatus according to the embodiment;

FIG. 3 is an explanatory diagram showing an operation example of print-job input processing of the image forming apparatus according to the embodiment;

FIG. 4 is an explanatory diagram showing an operation example of print-job print processing of the image forming apparatus according to the embodiment;

FIG. 5 is an explanatory diagram of a histogram used to calculate coverage;

FIG. 6A and FIG. 6B are explanatory diagrams showing an example of the relationship between a rotation angle and page coverage;

FIG. 7 illustrates a conceptual image of coverage calculation scopes;

FIG. 8 illustrates a conceptual image of coverage calculation scopes in which gap areas are considered;

FIG. 9 is a flowchart of a histogram forming process of the image forming apparatus; and

FIG. 10 is a flowchart of a print-job print process of the image forming apparatus.

### DETAILED DESCRIPTION OF THE EMBODIMENTS

Hereinafter, an embodiment of the present invention (hereinafter, referred to as “present embodiment”) will be described in detail with reference to the drawings. However, the scope of the invention is not limited to the disclosed embodiment. Note that each drawing is schematically shown to the extent that the present invention can be sufficiently understood. Therefore, the present invention is not limited to the illustrated examples. Moreover, the identical reference numerals are given to the common components or the same components in each figure, and duplicate descriptions thereof are omitted.

### Embodiment

### Configuration of Image Forming Apparatus

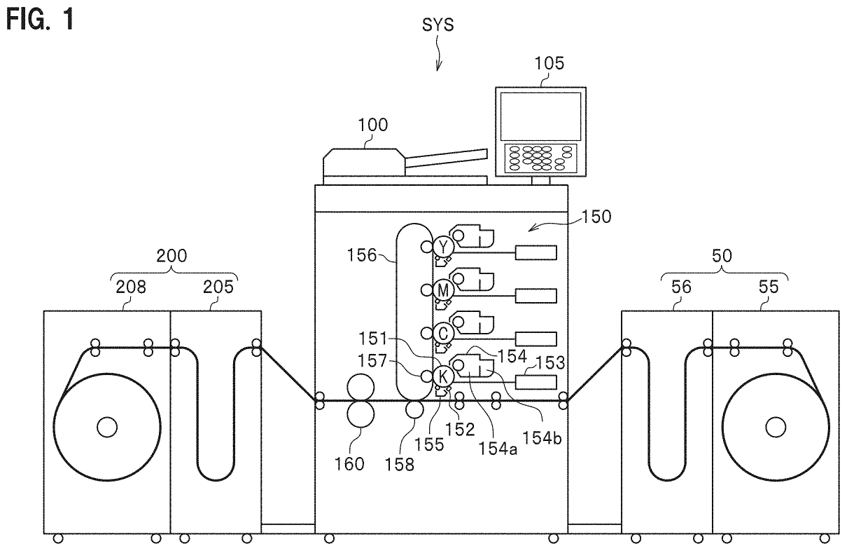

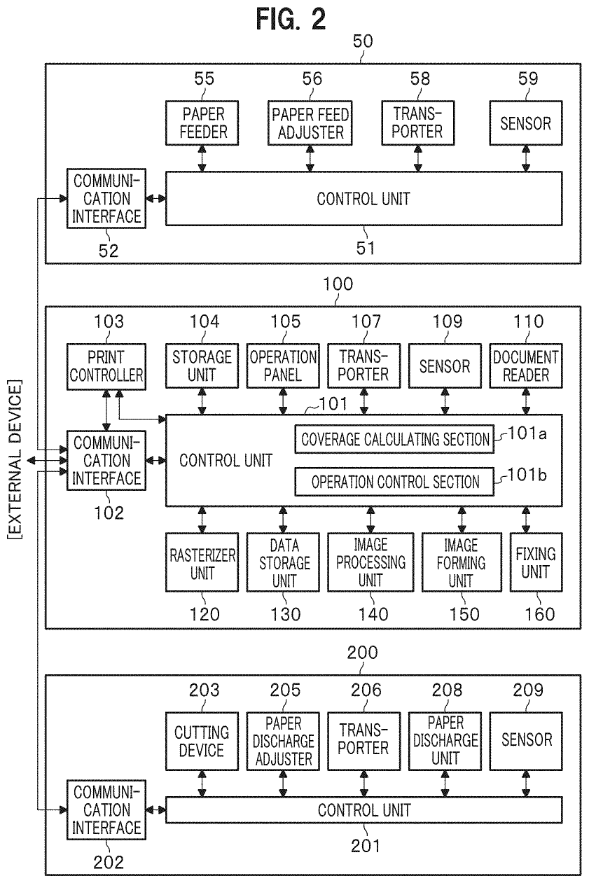

Hereinafter, the configuration of an image forming apparatus according to the present embodiment will be described with reference to FIG. 1 and FIG. 2. FIG. 1 is a block diagram of an entire image forming system including the image forming apparatus according to the present embodiment. FIG. 2 is an internal block diagram of the image forming apparatus according to the present embodiment.

Herein, the image forming apparatus according to the present embodiment will be described assuming that it is configured as a tandem-type intermediate transfer color printer. Herein, the image forming apparatus will be described assuming that it prints color images on continuous paper such as roll paper. Note that the image forming apparatus may be configured to include a facsimile function, a scanner function, a copy function and the like. Note that the terms of “upstream” and “downstream” are used with respect to the transport direction of the continuous paper or the traveling direction of an intermediate transfer belt.

As shown in FIG. 1, the image forming apparatus 100 according to the present embodiment constitutes, together with a paper feeding device 50 and a paper discharge device 200, an image forming system SYS. Note that the image forming system SYS may be configured to include other devices (not shown).

The image forming system SYS is capable of forming an image on continuous paper. The continuous paper is a long sheet having a longer sheet length in the transfer direction than a standard size sheet. The continuous paper is used, for example, in such an application that labels in a seal format such as address, serial number, and product indication are printed repeatedly.

As shown in FIG. 2, the paper feeding device 50 includes a control unit 51, a communication interface 52, a paper feeder 55, a paper feed adjuster 56, a transporter 58, and a sensor 59. The control unit 51 controls each constituent component in the paper feeding device 50 according to an instruction from a control unit 101 of the image forming apparatus 100. The communication interface 52 communicates with other apparatuses such as the image forming apparatus 100. The paper feeder 55 feeds the continuous paper from a paper roll toward the image forming apparatus 100. The paper feed adjuster 56 absorbs fluctuations in the transport speed of the paper fed from the paper feeder 55 while adjusting the tension and slack of the paper. The transporter 58 transports the paper in the paper feeding device 50. The sensor 59 detects various types of statuses regarding paper transportation.

The image forming apparatus 100 includes the control unit 101, a communication interface 102, a print controller 103, a storage unit 104, an operation panel 105, a transporter 107, a sensor 109, a document reader 110, and a rasterizer unit 120, a data storage unit 130, an image processing unit 140, an image forming unit 150 and a fixing unit 160.

The control unit 101 controls each constituent component in the image forming apparatus 100. The communication interface 102 communicates with other apparatuses (an external device, the paper feeding device 50, the paper discharge device 200, and the like). The print controller 103 receives print-job data described in a page description language from an external device and stores the received print-job data as necessary. The storage unit 104 stores various types of settings. The operation panel 105 receives operations inputted by a user and displays the status of the image forming apparatus 100. The transporter 107 transports the paper in the image forming apparatus 100. The sensor 109 detects various types of statuses regarding image formation and paper transportation. The document reader 110 reads an image of a document by an imaging element to generate document image data.

The rasterizer unit 120 performs raster image processing (RIP) on the print-job data, which is received by the print controller 103 and described in a page description language, to convert the data into bitmap image data called raster image data, which is used for image formation. The data storage unit 130 stores image data for forming an image and stores various types of data. Note that the data storage unit 130 includes a read image memory for storing received image data, and a print image memory for storing and outputting image data for image formation. The image processing unit 140 executes various types of image processing necessary for image formation. The image forming unit 150 forms an image on the paper according to an image forming command and to the image data stored in the print image memory of the data storage unit 130. The image forming unit 150 is disposed upstream of the fixing unit 160 in the paper transport direction (see FIG. 1). The specific configuration of the image forming unit 150 will be described later. The fixing unit 160 stabilizes (fixes) the image (toner image) formed by toner (developer) on the paper with heat and pressure.

The paper discharge device 200 includes a control unit 201, a communication interface 202, a cutting device 203, a paper discharge adjuster 205, a transporter 206, a paper discharge unit 208, and a sensor 209. The control unit 201 controls constituent components in the paper discharge device 200 under the control of the control unit 101. The communication interface 202 communicates with other apparatuses such as the image forming apparatus 100. The cutting device 203 cuts the continuous paper at predetermined positions. The paper discharge adjuster 205 absorbs fluctuations in the transport speed of the paper discharged from the image forming apparatus 100 while adjusting the tension of the paper. The transporter 206 transports the paper in the paper discharge device 200. The paper discharge unit 208 rolls up the continuous paper from the image forming apparatus 100 into a roll shape and discharges the resultant paper roll. The sensor 209 detects various types of statuses regarding paper transportation.

The image forming apparatus 100 according to the present embodiment calculates coverage over several meters to several hundreds of meters before starting a print job and performs control according to the coverage. For that purpose, the image forming apparatus 100 according to the present embodiment includes a coverage calculating section 101a and an operation control section 101b in the control unit 101. The coverage calculating section 101a calculates moving average coverage over a predetermined print length using image data, prior to starting the print job. The operation control section 101b controls an image forming operation related to toner usage in such a way that a result of comparing the value of moving average coverage with one or both of a predetermined maximum threshold and a predetermined minimum threshold is reflected in the image forming operation.

### Configuration of Image Forming Unit

As illustrated in FIG. 1, the image forming unit 150 of the image forming apparatus 100 includes a photosensitive drum 151, a charging device 152, an exposure device 153, a developing device 154, and a drum cleaner 155, an intermediate transfer belt 156, a primary transfer roller 157, and a secondary transfer roller 158.

The photosensitive drum 151 is an image carrier that temporarily carries an image (toner image) formed of toner. The photosensitive drum 151 rotates in the counterclockwise direction in the configuration shown in FIG. 1. The charging device 152 is a device for uniformly charging the surface of the photosensitive drum 151. The exposure device 153 is a device that exposes the surface of the photosensitive drum 151 according to the image data to form an electrostatic latent image on the surface of the photosensitive drum 151. The exposure device 153 is constituted by a laser irradiation device, for example. The developing device 154 causes the toner to adhere to the surface of the photosensitive drum 151 by triboelectric charging, and makes the electrostatic latent image formed on the surface of the photosensitive drum 151 appear as a toner image (develops the toner image). The developing device 154 includes a hopper 154a for storing the toner used in the developing device 154, and a toner supply part 154b for supplying the toner to the hopper 154a. The drum cleaner 155 is a mechanism for cleaning the surface of the photosensitive drum 151. The intermediate transfer belt 156 is an endless belt to which the toner image formed on the surface of the photosensitive drum 151 is transferred. The intermediate transfer belt 156 travels in the clockwise direction in the configuration shown in FIG. 1. The primary transfer roller 157 is a member for transferring the toner image formed on the surface of the photosensitive drum 151 to an outer peripheral surface of the intermediate transfer belt 156. The primary transfer roller 157 is disposed at a position facing the photosensitive drum 151, on the inner peripheral side of the intermediate transfer belt 156. The primary transfer roller 157 is applied with a voltage from a voltage supply unit not shown, and thereby attracts the toner image formed on the surface of the photosensitive drum 151 to transfers it to the intermediate transfer belt 156. The secondary transfer roller 158 is a member for transferring the toner image transferred to the outer peripheral surface of the intermediate transfer belt 156 to the paper. The secondary transfer roller 158 is disposed on the outer peripheral side of the intermediate transfer belt 156, at a position downstream of the photosensitive drum 151 for black (K). The secondary transfer roller 158 has a configuration similar to that of the primary transfer roller 157. That is, the secondary transfer roller 158 is applied with a voltage from a voltage supply unit not shown, and thereby transfers the toner image transferred to the outer peripheral surface of the intermediate transfer belt 156 to the paper.

Note that in the present embodiment, the image forming apparatus 100 has four photosensitive drums 151, four charging devices 152, four exposure devices 153, four developing devices 154, four drum cleaner 155, and four primary transfer rollers 157 as four sets of constituent elements corresponding to colors of yellow (Y), magenta (M), cyan (C), and black (K), respectively. These four sets of constituent elements have the same configuration except that the color of the toner stored in the developing device 154 is different. In the following, when the four sets of constituent elements respectively corresponding to the colors of yellow (Y), magenta (M), cyan (C), and black (K) are distinguished, descriptions will be given with English letters “Y”, “M”, “C” and “K” appended to the reference numerals given to each set of constituent elements.

Using the four sets of constituent elements respectively corresponding to those colors, the image forming apparatus 100 can form a multi-color image by forming a single color image on each of the surfaces of the photosensitive drums 151Y, 151M, 151C and 151K and transferring the single color images onto the outer peripheral surface of the intermediate transfer belt 156 in an overlapping manner.

### Operation of Image Forming Apparatus

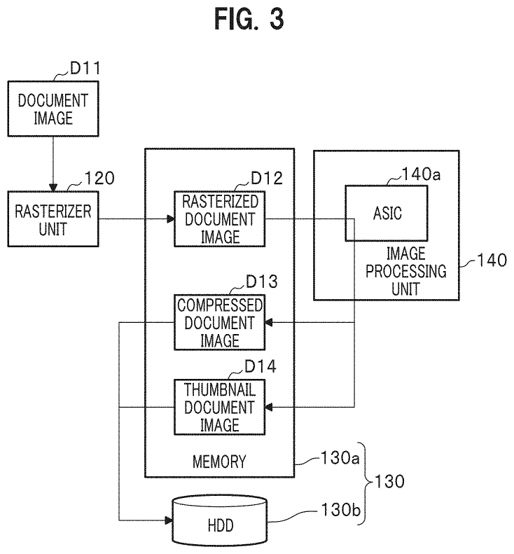

Hereinafter, the operation of the image forming apparatus 100 will be described with reference to FIG. 3 to FIG. 10. Note that the image forming apparatus 100 according to the present embodiment operates according to a time measured by a timer not shown. Furthermore, a series of operations to be performed by the image forming apparatus 100 of the present embodiment are performed by a central processing unit (CPU) executing a computer program stored in a readable manner in advance in a storage unit not shown. In addition, each piece of information is temporarily stored in the storage unit 104 in a readable manner, and then outputted to a predetermined component that performs a subsequent process. In addition, communication between devices is performed in such a way that a receiving device temporarily stores information received via communication in the storage unit 104 and thereafter reads out the information from the storage unit 104. Hereinafter, since these processes are frequently used in the field of information processing, detailed descriptions thereof will be omitted.

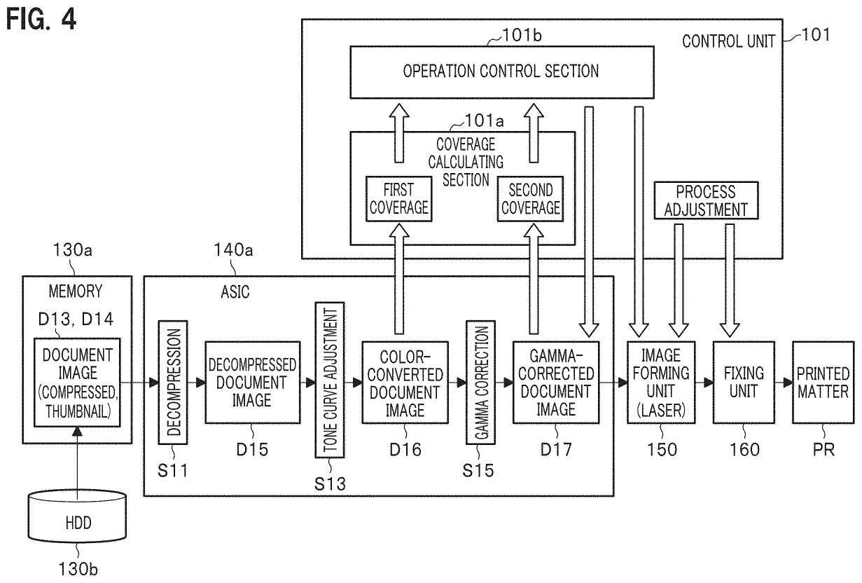

At the time of printing, the image forming apparatus 100 performs print-job input processing (see FIG. 3) and print-job print processing (see FIG. 4). FIG. 3 is an explanatory diagram showing an operation example of print-job input processing of the image forming apparatus 100. FIG. 4 is an explanatory diagram showing an operation example of print-job print processing of the image forming apparatus 100.

### Print-Job Input Processing

As shown in FIG. 3, the image forming apparatus 100 performs the following operations at the time of print-job input processing.

First, the rasterizer unit 120 of the image forming apparatus 100 receives document image data D11, such as PDF (Registered Trademark) data, from an external device or the document reader 110. The rasterizer unit 120 performs raster image processing on the document image data D11 to create rasterized document image data D12 in a bitmap format and stores it in the memory 130a.

Next, the image processing unit 140 performs lossy compression on the rasterized document image data D12 with an ASIC 140a to generate compressed document image data D13, and also generates thumbnail document image data D14. Then, the image processing unit 140 stores the compressed document image data D13 and the thumbnail document image data D14 in the HDD 130b. Here, the ASIC 140a is an application specific integrated circuit. Compression is performed to reduce the size of the image data. For example, whereas the rasterized document image data D12 consumes 3.4 GB per meter, the compressed document image data D13 consumes only about 425 MB. The thumbnail document image data D14 represents an image subjected to an image degrading process (image subsampling process). The thumbnail document image data D14 is created to reduce the load on the HDD 130b when used for previewing purposes. The resolution of a display panel, such as the operation panel 105, is lower than that of the thumbnail document image data D14. Therefore, there is no difference in the quality of an image displayed on the display panel even when using the thumbnail document image data D14 generated by the image forming apparatus 100.

### Print-Job Print Processing

When the print-job input processing is completed, the print-job print processing is performed. As shown in FIG. 4, the image forming apparatus 100 performs the following operations at the time of print-job print processing.

First, the control unit 101 reads out the compressed document image data D13 or the thumbnail document image data D14 from the HDD 130b, then stores it in the memory 130a, and then transfer it to the ASIC 140a. The present embodiment will be described assuming that the thumbnail document image data D14 is transferred to the ASIC 140a.

Next, the control unit 101 performs (step S11) image decompression in the ASIC 140a to get decompressed document image data D15. Next, the control unit 101 performs (step S13) tone curve adjustment on the decompressed document image data D15 to get color-converted document image data D16. The tone curve adjustment is a process of converting the density of an image according to a setting. Next, the control unit 101 performs (step S15) gamma correction on the color-converted document image data D16 to get gamma-corrected document image data D17 and transfers it to the image forming unit 150. The image forming unit 150 forms single color images on the surfaces of the photosensitive drums 151 according to the gamma-corrected document image data D17, then transfers the single color images from the photosensitive drums 151 to the intermediate transfer belt 156 to form a multi-color image thereon, and further transfers the multi-color image on the intermediate transfer belt 156 to the continuous paper. Thereafter, the fixing unit 16 fixes the multi-color image on the continuous paper by pressing the continuous paper while heating. Thereby, the printed matter PR is created.

Note that the coverage calculating section 101a of the control unit 101 calculates coverage for each color component (Y, M, C, K) before the print job is started. At this time, the coverage calculating section 101a can calculate the coverage from either the color-converted document image data D16 after tone curve adjustment or the gamma-corrected document image data D17 after gamma correction. Here, the coverage calculated from the color-converted document image data D16 after tone curve adjustment is referred to as “first coverage” for the sake of convenience, and the coverage calculated from the gamma-corrected document image data D17 after gamma correction is referred to as “second coverage” for the sake of convenience.

The operation control section 101b of the control unit 101 adjusts the image forming operation related to toner usage according to the first coverage or the second coverage calculated by the coverage calculating section 101a, and controls the image forming unit 150 for example in such a way that the adjustment result is reflected in the operation to be performed by the image forming unit 150.

Examples of the control includes the following:

(1) The operation control section 101b temporarily stops the image forming operation at a print position corresponding to a predetermined limited length, when a coverage calculated over a relatively long first unit length (for example, 300 meters) is less than a first threshold. Here, the first threshold is a predetermined minimum threshold. On the other hand, when the coverage over the first unit length (for example, 300 meters) is greater than or equal to the first threshold, the operation control section 101b performs continuous printing up to an allowable length (for example, 1000 meters). Note that the first threshold corresponds to the minimum coverage threshold CTₘᵢₙ shown in FIG. 10 (see step 245 in FIG. 10) in a case where the later-described operation shown in FIG. 10 is performed with the later described coverage calculation length reference LT being the first unit length (for example, 300 meters).

In this way, the image forming apparatus 100 can perform continuous printing with a low coverage (for example, 3% or less) over a long length, and can prevent the halting of print process thereafter due to degradation of the developer.

(2) The operation control section 101b maintains the printing speed when a coverage calculated over a second unit length (for example, 10 meters) smaller than the first unit length (for example, 300 meters) is lower than a second threshold. Here, the second threshold is a predetermined maximum threshold. On the other hand, the operation control section 101b reduces the printing speed to a predetermined limited speed or less, when the coverage calculated over the second unit length (for example, 10 meters) is greater than or equal to the second threshold. Note that the second threshold corresponds to the maximum coverage threshold CTₘₐₓ shown in FIG. 10 (see step 235 in FIG. 10) in a case where the later-described operation shown in FIG. 10 is performed with the later described coverage calculation length reference LT being the second unit length (for example, 10 meters).

In this way, the image forming apparatus 100 reduces the printing speed when the amount of toner consumption exceeds the amount of the toner supplied from the toner supply part 154b to the hopper 154a. Thereby, the image forming apparatus 100 can reduce the amount of toner consumption and prevent failure in forming an image due to the toner supply being not in time.

(3) The operation control section 101b performs printing when a coverage calculated over a third unit length (for example, 3 meters) smaller than the second unit length (for example, 10 meters) is less than a third threshold. Here, the third threshold is a predetermined maximum threshold. On the other hand, when the coverage over the third unit length (for example, 3 meters) is greater than or equal to the third threshold, the operation control section 101b causes the hopper 154a to discard a part or all of the toner stored in the hopper 154a, then causes the toner supply part 154b to supply the toner from to the hopper 154a, and then starts printing. Note that the third threshold corresponds to the maximum coverage threshold CTₘₐₓ shown in FIG. 10 (see step 235 in FIG. 10) in a case where the later-described operation shown in FIG. 10 is performed with the later described coverage calculation length reference LT being the third unit length (for example, 3 meters).

In this way, the image forming apparatus 100 can prevent the toner in the hopper 154a from being exhausted when a coverage over any length is high. In addition, the image forming apparatus 100 can prevent the toner in the hopper 154a from being exhausted even when performing continuous printing in which printing speed is increased or a gap area of a certain width (for example, 1 mm) between pages is provided. This point will be described in detail below.

For example, in general, the toner in the hopper 154a becomes damp when left for a long time (for example, about 6 hours). Therefore, in such a case, a toner concentration sensor (not shown) provided in the hopper 154a cannot accurately measure the toner concentration (density) in the hopper 154a. The image forming apparatus 100 continues printing when the coverage over a third unit length (for example, 3 meters) is less than the third threshold, which is a predetermined maximum threshold. On the other hand, when the coverage over the third unit length (for example, 3 meters) is greater than or equal to the third threshold, the operation control section 101b causes the hopper 154a to discard a part or all of the toner stored in the hopper 154a, then causes the toner supply part 154b to supply the toner from to the hopper 154a, and then starts printing. That is, the image forming apparatus 100 supplies the toner until the toner in the hopper 154a has been replaced. Note that at this time, the image forming apparatus 100 supplies the toner with a predetermined constant supply amount. Furthermore, after the toner in the hopper 154a has been replaced, the image forming apparatus 100 supplies the toner in an amount according to sensor data measured by the toner concentration sensor (not shown). In this way, the image forming apparatus 100 can prevent the toner in the hopper 154a from being exhausted when the coverage over any length is high. In addition, the image forming apparatus 100 can prevent the toner in the hopper 154a from being exhausted even when performing continuous printing in which printing speed is increased or a gap area of a certain width (for example, 1 mm) between pages is provided. Note that when the toner supply amount is increased, the toner concentration (density) in the hopper 154a may be excessively increased to cause a problem. Therefore, in the present embodiment, the amount of toner supply is not increased.

Note that the following points are considered in the operation shown in FIG. 4.

(1) The rasterized document image data D12 is relatively large in size. Therefore, if the coverage calculating section 101a is configured to calculate the coverage from the rasterized document image data D12, it takes a relatively long time for the control unit 101 of the image forming apparatus 100 to read the rasterized document image data D12 from the HDD 130b. For example, reading rasterized document image data D12 with a desired length (for example, 1000 meters) requires time in the order of minutes. In addition, it also takes a relatively long time for the coverage calculating section 101a of the image forming apparatus 100 to calculate the coverage from the rasterized document image data D12. In view of this, the coverage calculating section 101a of the present embodiment is configured to calculate the coverage from the color-converted document image data D16 or the gamma-corrected document image data D17. The color-converted document image data D16 and the gamma-corrected document image data D17 are each generated from the compressed document image data D13 or the thumbnail document image data D14. The compressed document image data D13 and the thumbnail document image data D14 are generated from the rasterized document image data D12 by lossy compression. Lossy compression means a process of generating image data subjected to an image degrading process. From the image data subjected to the image degrading process, it is not possible to reproduce the image data before the degrading process. That is, the image data subjected to the image degrading process has been reduced in the data amount. The compressed document image data D13 and thumbnail document image data D14 are smaller in size than the rasterized document image data D12. Therefore, the image forming apparatus 100 can reduce the time required for the control unit 101 to read the compressed document image data D13 or the thumbnail document image data D14 from the HDD 130b. Moreover, the color-converted document image data D16 and the gamma-corrected document image data D17 are also smaller in size than the rasterized document image data D12. Therefore, the image forming apparatus 100 can also reduce the time required for the coverage calculating section 101a to calculate the coverage from the color-converted document image data D16 or the gamma-corrected document image data D17. Therefore, the image forming apparatus 100 can accelerate the processing.

(2) The image forming apparatus 100 can adjust (step S13) the density (color) of the output image by tone curve adjustment. The amount of tone conversion by the tone curve adjustment can be changed after the rasterized document image data D12 is generated.

(3) The image forming apparatus 100 can perform gamma correction in step S15 in order to compensate characteristics of individual devices (such as the degradation status of the photosensitive drum 151). The gamma correction is performed to cancel the individual characteristics so that the actual image printed on the printed matter PR is equivalent to the original image of the document image data D11. Note that, for example, a difference of two times in densities of image before gamma correction will cause a difference of two times in amounts of toner adhesion on the actual printed matter PR. However, a difference of two times in the density of image after gamma correction will not necessarily cause a difference of two times in the amount of toner adhesion on the actual printed matter PR.

(4) The maximum density of the image formed on the printed matter PR can be changed by a process adjustment (for example, adjustment to development, transfer voltage, a current, a laser light amount reference value in the image forming unit 150, etc.).

(5) The first coverage is calculated from the color-converted document image data D16. On the other hand, the second coverage is calculated from the gamma-corrected document image data D17 created to compensate characteristics of individual devices (such as the degradation status of the photosensitive drum 151). Thus, the first coverage better represents the amount of the toner adhered to the actual printed matter PR than the second coverage. Therefore, the first coverage is preferable than the second coverage as the coverage to be calculated. Note that the process adjustment is not reflected in the density of the image.

Note that the maximum density of the image formed on the printed matter PR is changed by process adjustment. However, in the operation example shown in FIG. 4, the change of the maximum density by the process adjustment is not considered in the calculation of the coverage from the image data. If the maximum density is changed by the process adjustment, the image formed on the printed matter PR is an image in which all the densities of 0 to 255 gradations have been amplified. Therefore, preferably, the image forming apparatus 100 may be configured to perform a predetermined density correction on the coverage in advance according to process adjustment values. That is, the coverage calculating section 101a of the image forming apparatus 100 may calculate the coverage using the image data subjected to the image degrading process and the image density correction.

According to the present embodiment, the ASIC 140a creates a histogram using the thumbnail document image data D14 as source image data for calculation in order to shorten the time for creating the histogram. However, the ASIC 140a may use the compressed document image data D13 instead of the thumbnail document image data D14. However, in this case, decompression needs to be performed. Note that the rasterized document image data D12 is not preferable because the time for creating the histogram is prolonged.

Note that the tone curve adjustment (step S13) and the gamma correction (step S15) are hereinafter simply referred to as “density correction” when they need not be distinguished from each other, because, although they have different purposes as described above, they each are a process for correcting the density of the image.

### Calculation of Page Coverage

The image forming apparatus 100 according to the present embodiment calculates coverage prior to starting a print job and the coverage is used to control the image forming operation. In the calculation of the coverage, it is preferable to satisfy the following conditions.

(1) The coverage is calculated on a per-continuous-print(-job) basis rather than on a per-page basis.

(2) The coverage is accurately calculated.

(3) The coverage is calculated at high speed.

(4) Usability is ensured (i.e., the user is informed of, during the printing process, how the next print job will be performed).

Hereinafter, a description will be given of a specific method of calculating the coverage. The coverage calculating section 101a calculates moving average coverage calculated over a predetermined print length using image data, prior to starting the print job. In this operation, the coverage calculating section 101a of the present embodiment calculates moving average coverage over later-described page coverages of a series of pages arranged in a print sequence and having a print length closest to a predetermined print length, wherein the page coverages of the series of pages are calculated using image data of the series of pages on a per-page basis.

Coverage is calculated by scanning all the pixels of the image data representing a page.

For example, coverage CV defined for 8-bit image data is calculated according to the following equation (1):

$$CV = \frac{{\sum }_{x}^{X} T ( {P}_{x} )}{255} / X * 100 ( \% ) \qquad ( 1 )$$

where X denotes the total number of the pixels in the image, Px denotes the density value of x-th pixel, and T(i) denotes the output obtained by applying tone curve conversion to pixel density i.

Note that the calculation time required for calculating the coverage CV by scanning the entire image increases according to the size of the image. Therefore, it is preferable to use image data of a small image in order to reduce the calculation time. Therefore, the image forming apparatus 100 may preferably have such a configuration that the coverage calculating section 101a calculates the coverage CV using image data subjected to an image degrading process by a lossy compression (e.g., thumbnail document image data D14).

In addition, the image forming apparatus 100 may preferably have such a configuration that the image processing unit 140 performs a density correction on the image data subjected to the image degrading process (for example, the thumbnail document image data D14) in accordance with a print job setting or an image forming setting. In addition, the coverage calculating section 101a may preferably calculate the coverage CV (and moving average coverage over pages) using the image data subjected to the image degrading process (for example, the thumbnail document image data D14) and the density correction. In this operation, the image processing unit 140 may preferably perform the image density correction on the image data subjected to the image degrading process, in accordance with the print job setting or the image forming setting. Furthermore, in this operation, the image processing unit 140 may preferably excludes a setting for reproducing (step S15) the density of original image data from the print job setting and use a setting for obtaining (step S13) a printed matter with an image printed thereon with a different density from the density of the original image data. In addition, the coverage calculating section 101a may preferably calculate the coverage CV using the image data subjected to the density correction. In this operation, the coverage calculating section 101a may correct the coverage CV by applying a predetermined multiplier, according to an image density setting which affects the highest density of the image to be formed. Note that the “print job setting” described above includes, for example, a setting related to a rotation angle of the image. Note that the “image forming setting” described above includes the image density setting which affects the highest density of the image to be formed.

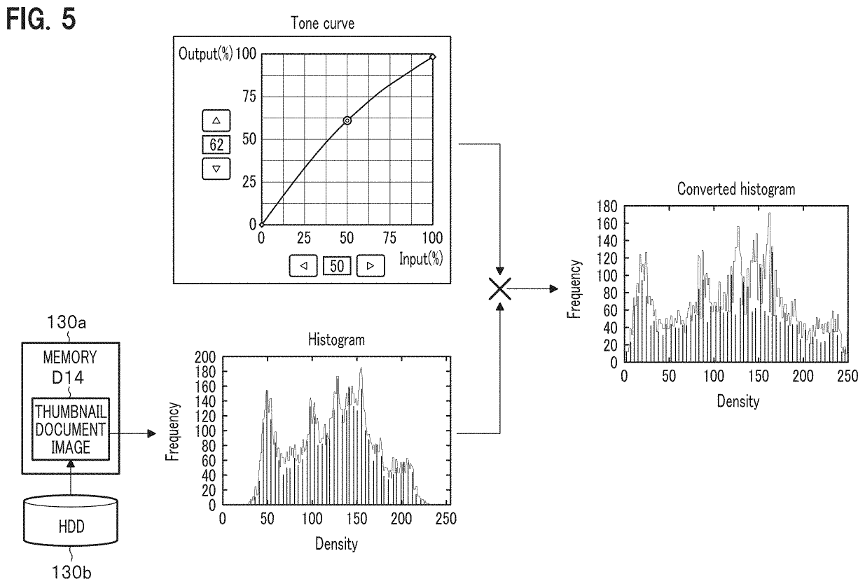

For example, as shown in FIG. 5, the ASIC 140a (see FIG. 4) of the image forming apparatus 100 according to the present embodiment creates a histogram from the thumbnail document image data D14. FIG. 5 is an explanatory diagram of a histogram used for calculating the coverage CV. In the illustrated example, the histogram represents frequencies of density values, where the horizontal axis represents density and the vertical axis represents frequencies of respective density values. Next, the ASIC 140a applies tone curve adjustment to the histogram to create a converted histogram. The setting of tone curve adjustment is performed by a user operating the operation panel 105 (see FIG. 1) prior to or during printing. Thereafter, the ASIC 140a calculates the coverage CV using the converted histogram. Thereby, the image forming apparatus 100 can calculate the coverage CV at high speed.

Note that the coverage CV can be calculated independent of the image size as follows.

For example, the coverage CV can be calculated by the following equation (2):

$$CV = \frac{{\sum }_{i = 0}^{255} T ( i ) * {H}_{i}}{255} / X \qquad ( 2 )$$

where X denotes the total number of pixels, T(i) denotes the output obtained by tone curve conversion of density i of an image (pixels), and Hi denotes the frequency of density i (number of pixels having density i).

The calculation amount of equation 2 described above does not depend on the image size. Therefore, the coverage calculating section 101a can calculate the coverage CV independent of the image size.

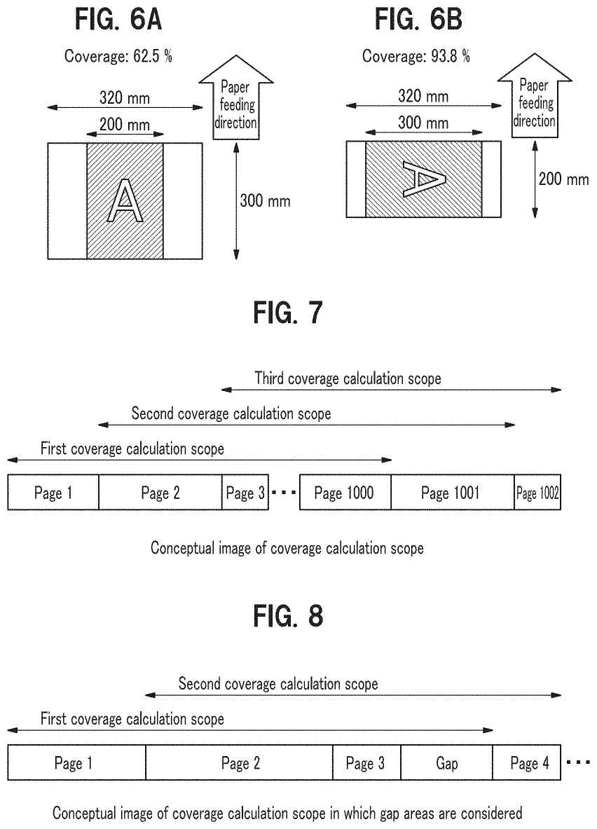

The coverage CV calculated by equation 2 described above depends only on the image represented by the image data, whereas the amount of the actual toner consumption varies depending on the image size. In addition, the coverage assessed per print length also varies depending on the rotation angle (see FIG. 6). Therefore, the toner consumption should be assessed according to a coverage represented by a fraction whose denominator is (maximum print width) x (paper feed length of page), where paper feed length depends on the rotation angle. Hereinafter, this coverage is called “page coverage”. FIG. 6 is an explanatory diagram showing an example of the relationship between the rotation angle and the page coverage. FIG. 6A shows an example of a case of forming an image with the longitudinal direction of the image for one page being aligned with the paper feeding direction. On the other hand, FIG. 6B shows an example in a case where the orientation of the image is rotated by 90 degrees with respect to FIG. 6A to align the short side direction of the image for one page with the paper feeding direction. In the example shown in FIG. 6A, the maximum print width is 320 mm, the paper feed length of the page is 300 mm, and the page coverage is 62.5%, whereas, in the example shown in FIG. 6B, the maximum print width is 320 mm, the paper feed length of the page is 200 mm, and the page coverage is 93.8%. Thus, the page coverage varies depending on the rotation angle.

### Print-Job Coverage Calculation

By the way, unlike a case where images are formed on cut sheets, the image forming apparatus 100 cannot correct the density by temporarily stopping printing at an arbitrary timing in the case of forming images continuously on continuous paper. Taking this into account, it is preferable that the image forming apparatus 100 change the image forming operation according to a coverage over several meters to several hundreds of meters. Therefore, it is preferable that the image forming apparatus 100 calculates not only single page coverages but also coverages based on the actual image forming operation. Furthermore, when the image forming apparatus 100 calculates coverage over the above described first unit length (for example, 300 meters), for a print job of 600 meters for example, it is preferable that the image forming apparatus 100 determines whether the coverage over the first unit length at any position in the print-job is less than the first threshold described above. From these viewpoints, it is preferable to calculate moving average coverage over a predetermined print length (coverage calculation scope), as shown in FIG. 7. FIG. 7 illustrates a conceptual image of coverage calculation scopes. In the illustrated example, the coverage calculation scope is defined as a length corresponding to 1000 pages but is not limited thereto and can be set to any value. Moreover, the coverage calculation scope varies depending on the size of the image in each page, the rotation angle of the image and the like.

In addition, in an actual image forming operation, a gap area is inserted between pages or print jobs (see FIG. 8). FIG. 8 illustrates a conceptual image of coverage calculation scopes for which gap areas are taken into account. These gap areas are areas that do not exist in the image data itself. Therefore, when the coverage is simply calculated from the image data only, the coverage fails to reflect the gap areas. Taking this into account, the coverage calculating section 101a according to the present embodiment calculates the moving average coverage over pages with assuming the gap areas as having a coverage of 0%.

### Processing Example of Embodiment

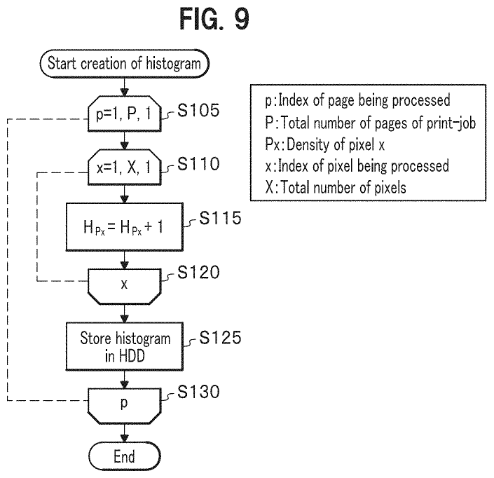

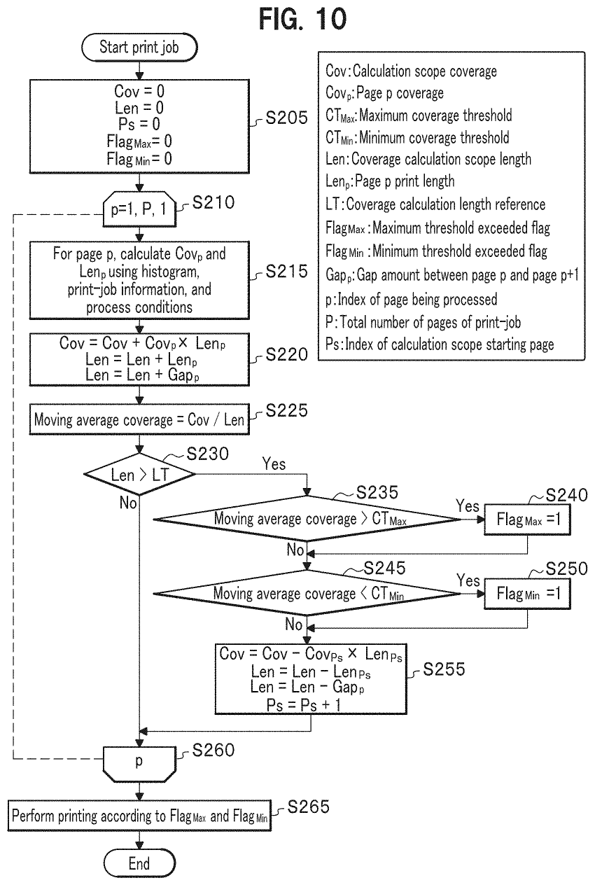

The specific operations of the image forming apparatus 100 according to the present embodiment are as in the flowcharts shown in FIG. 9 and FIG. 10. FIG. 9 is a flowchart of the histogram forming process performed by the image forming apparatus 100. FIG. 10 is a flowchart of the print-job print processing performed by the image forming apparatus 100. The following description assumes that the thumbnail document image data D14 is used to create the histogram and that the coverage to be calculated is the first coverage.

### Histogram Creation Process

The ASIC 140a (see FIG. 4) of the image processing unit 140 performs the processes illustrated in FIG. 9 to create histograms from the thumbnail document image data D14. In step S105, the ASIC 140a initializes page index variable p representing the index of the page being processed to 1, initializes variable P representing the total page number of the pages of the print-job, and initializes a page increment to 1. In step S110, the ASIC 140a initializes pixel index variable x representing the pixel being processed to 1, initializes variable X representing the total pixel number of the pixels in the thumbnail image of the page indexed by p, and initializes a pixel increment to 1. The ASIC 140a repeats getting the density value Px of the pixel indexed by x, incrementing the frequency (represented as Hₚₓ in FIG. 9) of the density value Px (step S115), and incrementing x by the pixel increment, until x reaches X (Step S120). As a result, the frequencies Hₚₓ for all the density values of 0 to 255 gradations are obtained for the page indexed by p.

This creates a histogram of the densities of the pixels in the page indexed by p. When pixel index x reaches the total pixel number X, the ASIC 140a stores (step S125) the histogram of the densities of the pixels in the page indexed by p in the HDD 130b. The ASIC 140a repeats (step S130) the processes from step S110 to step S125 until page index p reaches P, i.e., the total number of pages of the print-job. Thereby, the histograms for the number of print job pages are created.

Note that in the example shown in FIG. 9, it is assumed that some edits (changing output direction, addition of pages, deletion of pages, concatenating a plurality of print jobs, etc.) will be made to the print job after the histograms are created. For this reason, the image forming apparatus 100 does not calculate coverage at this stage of histogram creation.

### Print-Job Print Processing

After creating the histograms, upon receiving an actual printing instruction, the image forming apparatus 100 performs calculation of moving average coverage and an image forming operation according to the moving average coverage as shown in FIG. 10.

As shown in FIG. 10, in step S205, the coverage calculating section 101a of the control unit 101 initializes variables used in the process. Specifically, variable Cov, which represents a calculation scope coverage, is initialized to 0; variable Len, which represents a coverage calculation scope length, is initialized to 0; page index Ps, which represents a calculation scope starting page number, is initialized to 1; flag Flag_{Max}, which tracks whether a moving average coverage has exceeded a maximum threshold, is initialized to 0; and flag Flag_{Min}, which tracks whether the moving average coverage has exceeded a minimum threshold, is initialized to 0. In step S210, the coverage calculating section 101a initializes variables used for accessing histograms created in the processes from step S105 to step S130 in FIG. 9. Specifically, page index p, which represents the index of the page being processed, is initialized to 1; variable P, which represent the total number of the pages of the print-job, is initialized according to the print job, and a page increment is initialized to 1. The coverage calculating section 101a calculates (step S215) the page coverage Covₚ and gets the print length Lenₚ of page p, using the histogram of page p, the print-job information, and the process conditions. Next, in step S220, the coverage calculating section 101a gets the gap amount Gapₚ of the gap between page p and page (p+1) and updates the variables Cov and Len (calculation scope coverage and the coverage calculation scope length). Here, the value of the calculation scope coverage Cov is updated by adding Covₚ×Lenₚ, where Covₚ is the page coverage of page p and Lenₚ is the print length of page p. The value of Len, which represents the coverage calculation scope length, is updated by adding Lenₚ. The value of Len is further updated by adding the gap amount Gapₚ. Next, in step S225, the coverage calculating section 101a calculates a moving average coverage by Cov/Len (calculation scope coverage/coverage calculation scope length).

After step S225, the operation control section 101b determines (step S230) whether Len (current coverage calculation scope length) is larger than LT, where LT is a predetermined coverage calculation length reference.

If it is determined in step S230 that Len is larger than LT (Yes), the operation control section 101b determines (step S235) whether the moving average coverage Cov/Len is larger than CTₘₐₓ, where CTₘₐₓ is a predetermined maximum coverage threshold. If it is determined in step S235 that the moving average coverage Cov/Len is equal to or less than the maximum coverage threshold CTₘₐₓ (No), the process proceeds to step S260. On the other hand, if it is determined in step S235 that the moving average coverage Cov/Len is larger than the maximum coverage threshold CTₘₐₓ (Yes), the operation control section 101b sets (step S240) the value of flag Flag_{Max} to 1 indicating that the moving average coverage Cov/Len has exceeded the maximum coverage threshold CTₘₐₓ, and stores the flag in the memory 130a. Thereafter, the process proceeds to step S245.

If it is determined in step S235 that the moving average coverage Cov/Len is equal to or less than the maximum coverage threshold CTₘₐₓ (No), or after step S240, the operation control section 101b performs the process of step S245. In step S245, the operation control section 101b determines whether the moving average coverage Cov/Len is smaller than CTₘᵢₙ, where CTₘᵢₙ is a predetermined minimum coverage threshold.

If it is determined in step S245 that the moving average coverage Cov/Len is smaller than the minimum coverage threshold CTₘᵢₙ (Yes), the operation control section 101b sets (step S250) the value of flag Flag_{Min} to 1 indicating that the moving average coverage Cov/Len has exceeded the minimum coverage threshold CTₘᵢₙ, and stores the flag in the memory 130a. Thereafter, the process proceeds to step S255.

If it is determined in step S245 that the moving average coverage Cov/Len is greater than or equal to the minimum coverage threshold CTₘᵢₙ (No), or after step S250, the operation control section 101b performs the process of step S255. In step S255, the operation control section 101b modifies Cov (calculation scope coverage) and Len (coverage calculation scope length). Specifically, the value of Cov is updated by subtracting Cov_{Ps}×Lenₚₛ, where Cov_{Ps} represents the coverage of page Ps and Len_{Ps} represents the print length of page Ps. The value of Len, which represents the coverage calculation scope length, is updated by subtracting the value of Len_{Ps}. The value of Len is further updated by subtracting the gap amount Gapₚ from Len. Furthermore, page index Ps, which represents the calculation scope starting page number, is incremented by one.

The control unit 101 repeats (step S260) the processes from step S215 to step S255 until page index p reaches P (total number of the pages of the print-job). Thereby, the calculation of the moving average coverage and threshold determination for the number of job pages are performed.

After step S260, the operation control section 101b performs printing in an image forming operation according to the value of the maximum threshold exceeded flag Flag_{Max} and the value of the minimum threshold exceeded flag Flag_{Min} (step S265). Thereby, a series of routine processes is completed.

Note that either or both of the maximum threshold exceeded flag Flag_{Max} and the minimum threshold exceeded flag Flag_{Min} having been set to 1 indicates an undesirable situation. Therefore, in this case, the image forming apparatus 100 performs a special image forming operation.

Note that the operations shown in FIG. 10 are performed for each color of the toners of yellow (Y), magenta (M), cyan (C), and black (K). Moreover, the processing shown in FIG. 10 is performed for three cases where the predetermined coverage calculation length reference LT is set to: (1) first unit length (e.g., 300 meters), (ii) second unit length (e.g., 10 meters), or (iii) third unit length (e.g., 3 meters) described above. The maximum coverage threshold CTₘₐₓ and minimum coverage threshold CTₘᵢₙ described above are prepared in advance for each unit length. In addition, the image forming operation according to the value of the maximum threshold exceeded flag Flag_{Max} and the value of the minimum threshold exceeded flag Flag_{Min} are predetermined for each length unit.

According to the flowchart shown in FIG. 10, the image forming apparatus 100 calculates the coverage of each page sequentially from the first page and calculates calculation scope coverage by summing up (page coverage of page p)×(length of page p) for all the pages in the coverage calculation scope. When the calculation scope length reaches the length reference value LT, the image forming apparatus 100 calculates a moving average coverage by dividing the calculation scope coverage by the calculation scope length. The moving average coverage represents a weighted coverage weighting the page coverage of each page according to the paper feeding direction length of the page. This average coverage in the coverage calculation scope means the moving average coverage.

Thereafter, the image forming apparatus 100 compares the moving average coverage with the predetermined maximum threshold and the minimum threshold, records the results, and then removes the first page from the calculation scope, and adds the next page to the calculation scope to calculate the moving average coverage of the updated calculation scope.

The image forming apparatus 100 can perform the calculation of the moving average coverage over pages and the comparison of the moving average coverage with the thresholds by repeating these processes for all the pages. In this operation, the coverage calculating section 101a regards the coverage of gap areas between pages or jobs as 0% and adds the length of the gap areas to the calculation scope length, to calculate the moving average coverage over pages. In this way, the coverage calculating section 101a can obtain the moving average coverage over pages in such a way that gap areas are reflected in the moving average coverage.

The image forming apparatus 100 according to the present embodiment can form images of a plurality of pages on continuous paper with suitable operations. Therefore, the image forming apparatus 100 can improve the processing capability when forming images of a plurality of pages on continuous paper.

### Supplementary Description of Operation Example

Note that the operation example described above is merely an example, and the operation of the image forming apparatus 100 can be modified as long as the calculation of the moving average coverage and the threshold comparison are performed.

For example, the operations can be modified as follows.

(a) Processing may be performed per each line of image data instead of processing per each page.

(b) The calculation scope coverage is calculated when the calculation scope length exceeds a coverage calculation length reference. However, calculation scope coverage may be calculated using pages up to the page immediately before the calculation scope length exceeds the coverage calculation length reference. Alternatively, the pages may be selected in such a way as to reduce the error between the coverage calculation scope length and the coverage calculation length reference.

(c) The comparison between the moving average coverage and the threshold may be performed only with one of the maximum value and the minimum value.

(d) The image data itself may be used instead of the histogram.

(e) The process conditions may not necessarily be used.

(f) The coverage calculation may be performed at the time of print-job input.

As described above, with the image forming apparatus 100 according to the present embodiment, it is possible to improve the processing capability when forming images of a plurality of pages on continuous paper.

The present invention is not limited to the above embodiment, and modifications can be made within the scope of not departing from the spirit of the present invention.

For example, in the embodiment described above, “less than a first threshold” in “when a coverage calculated over a relatively long first unit length (for example, 300 meters) is less than a first threshold” may be changed to “less than or equal to the first threshold”.

In addition, for example, “greater than or equal to the second threshold” in “when the coverage calculated over the second unit length (for example, 10 meters) is greater than or equal to the second threshold” may be changed to “greater than the second threshold”.

Similarly, for example, “greater than or equal to the third threshold” in “when the coverage over the third unit length (for example, 3 meters) is greater than or equal to the third threshold” may be changed to “greater than the third threshold”.

Although embodiments of the present invention have been described and illustrated in detail, the disclosed embodiments are presented for purposes of illustration and example only and not limitation. The scope of the present invention should be interpreted by terms of the appended claims.

What is claimed is:

1. An image forming apparatus for forming images of a plurality of pages on continuous paper according to image data of the images, the image forming apparatus comprising:
a coverage calculating section that calculates a moving average coverage over a predetermined print length using the image data before starting a print job; and
an operation control section that controls an image forming operation related to toner usage according to a result of comparison between the moving average coverage and one or both of a predetermined maximum threshold and a predetermined minimum threshold.

2. The image forming apparatus according to claim 1, further comprising
an image processing unit that processes the image data,
wherein the image processing unit applies an image degrading process by lossy compression to the image data, and
wherein the coverage calculating section calculates the moving average coverage using the image data that has been subjected to the image degrading process.

3. The image forming apparatus according to claim 2,
wherein the image degrading process by lossy compression is performed by subsampling.

4. The image forming apparatus according to claim 1,
wherein the coverage calculating section calculates the moving average coverage using image data of a series of pages in the plurality of pages, the series of pages arranged in a print sequence and having a print length closest to the predetermined print length.

5. The image forming apparatus according to claim 1,
wherein the coverage calculating section calculates the moving average coverage using a histogram created using the image data in advance.

6. The image forming apparatus according to claim 5,
wherein the histogram is created using image data obtained by applying density conversion to the image data of the images of the plurality of pages.

7. The image forming apparatus according to claim 2,
wherein the image processing unit applies density correction to the image data subjected to the image degrading process according to a print job setting or an image forming setting; and
the coverage calculating section calculates the moving average coverage using the image data subjected to the density correction.

8. The image forming apparatus according to claim 7,
wherein, when applying the density correction, the image processing unit excludes a setting for reproducing a density of an original image from the print job setting and uses a setting for obtaining a printed matter with an image printed thereon with a different density from the density of the original image, and
wherein the coverage calculating section calculates page coverages of the plurality of pages using the image data subjected to the density correction on a per-page basis, and
wherein the coverage calculating section calculates the moving average coverage by computing a moving average over the page coverages of a series of pages in the plurality of pages.

9. The image forming apparatus according to claim 8,
wherein the print job setting includes an image rotation setting related to an image rotation angle, and
wherein the coverage calculating section calculates the page coverages according to the image rotation setting.

10. The image forming apparatus according to claim 7,
wherein the density correction is a first density correction,
wherein the image forming setting includes a image density setting which affects a highest density of the images to be formed,
wherein the image processing applies a second density correction to the image data subjected to the first density correction by applying a predetermined multiplier according to the image density setting,
wherein the coverage calculating section calculates page coverages of the plurality of pages using the image data subjected to the second density correction on a per-page basis, and
wherein the coverage calculating section calculates the moving average coverage by computing a moving average over the page coverages of a series of pages in the plurality of pages.

11. The image forming apparatus according to claim 1,
wherein the coverage calculating section calculates the moving average coverage assuming that gap areas to be formed on the continuous paper have a 0% coverage.

12. The image forming apparatus according to claim 1,
wherein the operation control section temporarily stops an image forming operation at a predetermined limited length when the moving average coverage is less than a first threshold, which is a predetermined minimum threshold.

13. The image forming apparatus according to claim 1,
wherein the operation control section reduces a printing speed to a predetermined limit speed or less when the moving average coverage is greater than or equal to a second threshold, which is a predetermined maximum threshold.

14. The image forming apparatus according to claim 1,
wherein the image forming apparatus further comprises an image forming unit for forming an image, the image forming unit comprising: a developing device for developing an image, a hopper for storing toner to be used in the developing device, and a toner supply part for supplying the toner to the hopper, and
wherein the operation control section
causes the hopper to discard a part or all of the toner stored in the hopper when the moving average coverage is greater than or equal to a third threshold, which is a predetermined maximum threshold, then causes the toner supply part to supply toner to the hopper, and then starts printing.

15. An image forming method to be executed by an image forming apparatus to form images of a plurality of pages on continuous paper according to image data of the images of the plurality of pages, the image forming method comprising:
calculating a moving average coverage over a predetermined print length using the image data prior to starting a print job;
comparing the moving average coverage with one or both of a predetermined maximum threshold and a predetermined minimum threshold; and
controlling an image forming operation related to toner usage in such a way that a result of the comparison is reflected in the image forming operation.
